(19) United States
(12) Patent Application Publication
(10) Pub. No.: US 2023/0064717 A1
(43) Pub. Date: Mar. 2, 2023

(54) POWER STORAGE MODULE

(71) Applicant: TOYOTA JIDOSHA KABUSHIKI KAISHA, Toyota-shi Aichi-ken (JP)

(72) Inventors: Kentaro Suzuki, Kariya-shi Aichi-ken (JP); Kengo Iwakura, Toyota-shi Aichi-ken (JP)

(73) Assignee: TOYOTA JIDOSHA KABUSHIKI KAISHA, Toyota-shi Aichi-ken (JP)

(21) Appl. No.: 17/863,833

(22) Filed: Jul. 13, 2022

(30) Foreign Application Priority Data
Aug. 31, 2021 (JP) 2021-141132

(51) Int. Cl. H01M 50/169; H01M 50/15

(52) U.S. Cl. CPC H01M 50/169; H01M 50/15

(57) ABSTRACT

A power storage module includes a power storage cell and a cell holder. The power storage cell includes a case and a cover. The cover has a reference surface formed flatly. A welded portion is formed in a boundary portion between the case and the cover. The welded portion includes a protrusion portion having a shape protruding upward from the reference surface. The cell holder includes a frame body and an abutment wall, the frame body including a pair of first side walls and a second side wall. The abutment wall includes a cover abutment portion including an abutting surface configured to abut with the reference surface, and a facing portion facing the protrusion portion in the up-down direction. The facing portion has a shape recessed upward from the reference surface such that the facing portion avoids interference with the protrusion portion.

### CROSS-REFERENCE TO RELATED APPLICATION

This application claims priority to Japanese Patent Application No. 2021-141132 filed on Aug. 31, 2021, incorporated herein by reference in its entirety.

### BACKGROUND

### 1. Technical Field

This disclosure relates to a power storage module.

### 2. Description of Related Art

In the related art, a power storage module to be provided in a vehicle or the like has been known. For example, Japanese Unexamined Patent Application Publication No. 2016-219185 (JP 2016-219185 A) describes a power storage device module including a battery and a cell holder. The battery includes a case the upper end of which is opened, a cover configured to close the opening of the case, and a welded portion where the opening edge of the case is welded to the edge of the cover. The cell holder includes a back wall portion provided at a position facing the back surface of the case, a top wall portion provided at a position facing the top surface of the cover, and a pair of side wall portions. The side wall portions are provided at respective positions facing respective side surfaces of the case. A second recessed portion is provided on the inner surface of each of the side wall portions such that the welded portion is relieved. The second recessed portion is recessed to a direction distanced from the side surface of the case.

### SUMMARY

In a power storage device module as described in JP 2016-219185 A, in a case where a welded portion formed by welding between a case and a cover of a power storage cell is formed in a shape protruding upward from the cover, when a cell holder interferes with the welded portion, the accuracy of positioning between the power storage cell and the cell holder in the up-down direction decreases.

An object of this disclosure is to provide a power storage module that can improve the accuracy of positioning between a power storage cell and a cell holder in the up-down direction.

A power storage module according to one aspect of this disclosure includes a power storage cell and a cell holder. The cell holder is configured to hold the power storage cell. The power storage cell includes a case having a shape opened upward, and a cover having a shape closing an opening of the case, the cover being welded to the case. The case includes a pair of first side surfaces placed such that the first side surfaces face each other, and a pair of second side surfaces placed such that the second side surfaces face each other, the second side surfaces being perpendicular to the first side surfaces. The cover has a reference surface formed flatly. A welded portion formed by welding between the case and the cover is formed in a boundary portion between the case and the cover. The welded portion includes a protrusion portion having a shape protruding upward from the reference surface. The cell holder includes a frame body and an abutment wall. The frame body includes a pair of first side walls placed such that the first side walls face the first side surfaces, respectively, and a second side wall via which the first side walls are connected to each other, the second side wall facing a corresponding one of the second side surfaces. The abutment wall is connected to an upper end part of the frame body and configured to abut with the reference surface of the cover. The abutment wall includes a cover abutment portion including an abutting surface configured to abut with the reference surface, and a facing portion connected to the cover abutment portion, the facing portion facing the protrusion portion in the up-down direction. The facing portion has a shape recessed upward from the reference surface such that the facing portion avoids interference with the protrusion portion.

With this disclosure, it is possible to provide a power storage module that can improve the accuracy of positioning between a power storage cell and a cell holder in the up-down direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating the configuration of a power storage module according to one embodiment of this disclosure;

FIG. 2 is a perspective view of a power storage cell;

FIG. 3 is a sectional view taken along a line in FIG. 1;

FIG. 4 is a sectional view taken along a line IV-IV in FIG. 1; and

FIG. 5 is a sectional view schematically illustrating a modification of a facing portion.

### DETAILED DESCRIPTION OF EMBODIMENTS

The following will describe an embodiment of this disclosure with reference to the drawings. Note that, in the drawings referred to in the following description, the same reference number is assigned to identical members or a member equivalent to them.

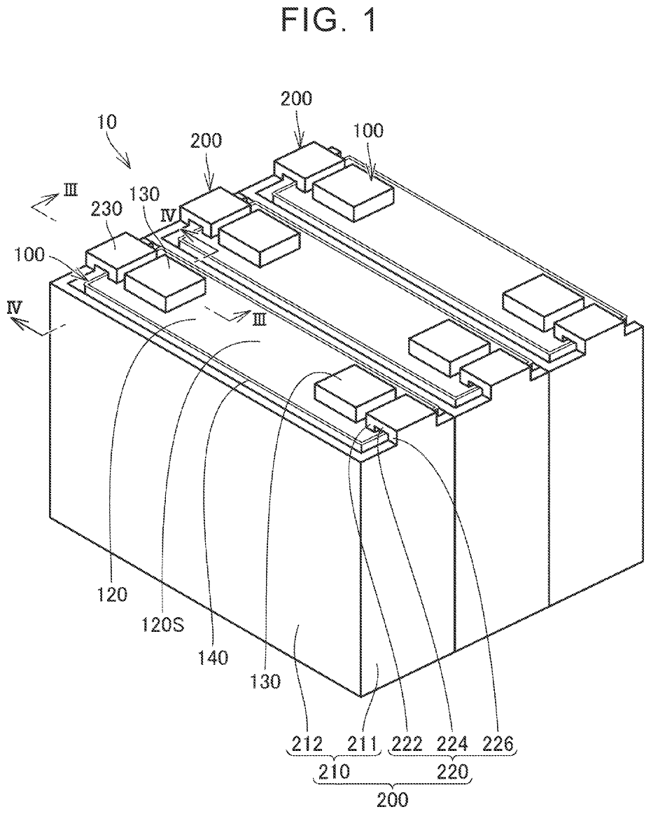

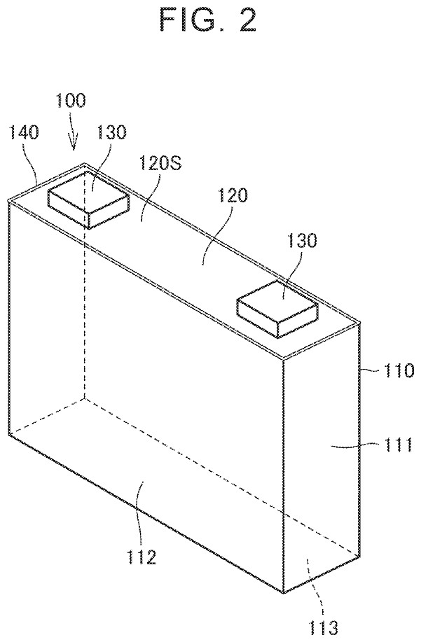

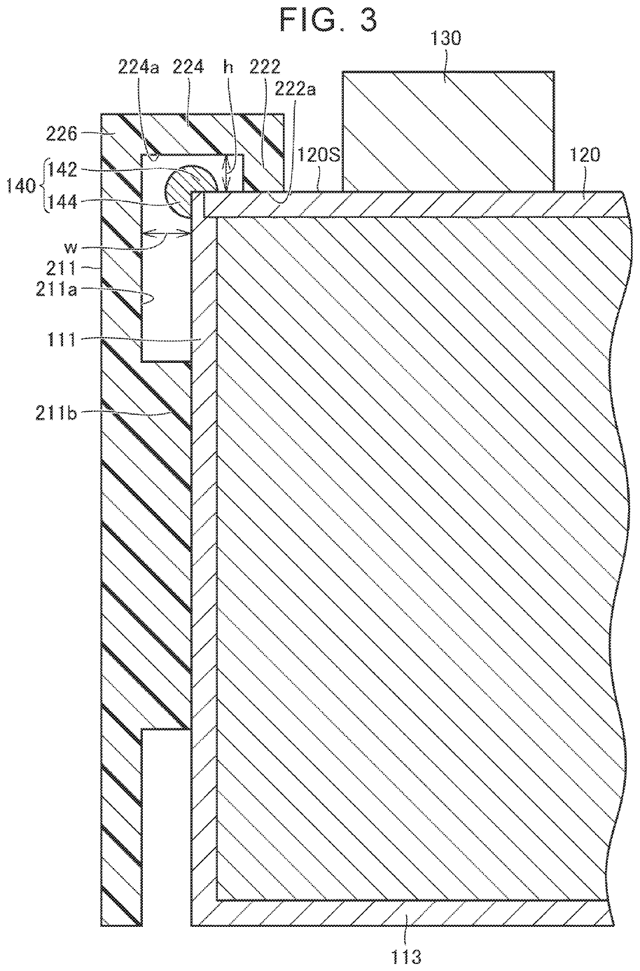

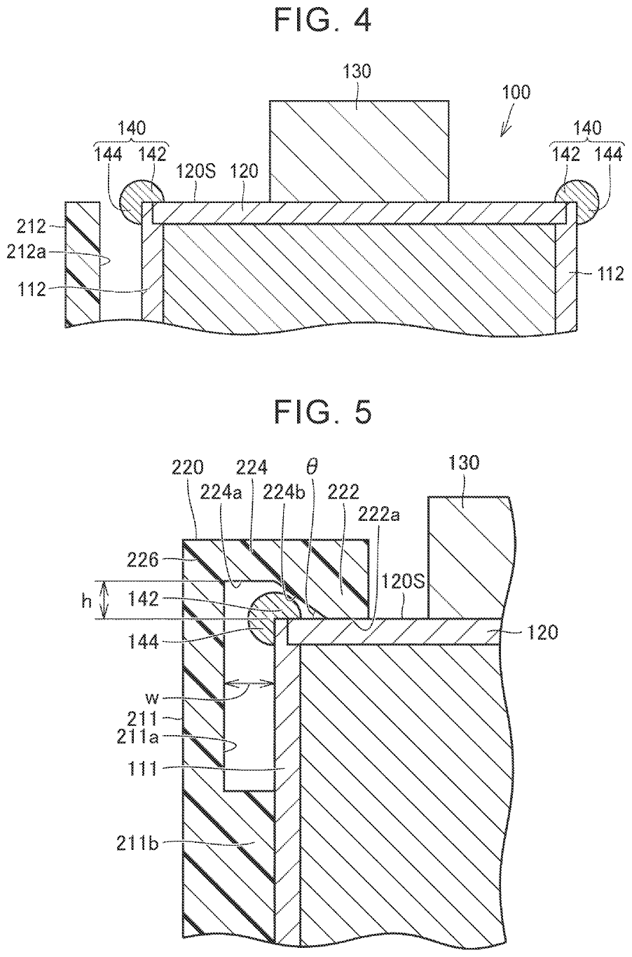

FIG. 1 is a perspective view schematically illustrating the configuration of a power storage module according to one embodiment of this disclosure. FIG. 2 is a perspective view of a power storage cell. FIG. 3 is a sectional view taken along a line III-III in FIG. 1. FIG. 4 is a sectional view taken along a line IV-IV in FIG. 1. A power storage module 10 is provided in a vehicle, for example.

As illustrated in FIGS. 1 to 4, the power storage module 10 includes a plurality of power storage cells 100 and a plurality of cell holders 200.

The power storage cells 100 are arranged side by side in one direction. The power storage cells 100 may be lithium-ion batteries, for example. Each of the power storage cells 100 is formed in a rectangular-solid shape. As illustrated in FIG. 2, each of the power storage cells 100 includes a case 110, a cover 120, and a pair of external terminals 130.

The case 110 includes a pair of first side surfaces 111, a pair of second side surfaces 112, and a bottom surface 113. The first side surfaces 111, the second side surfaces 112, and the bottom surface 113 are each formed in a rectangular shape.

The first side surfaces 111 are placed to face each other. The second side surfaces 112 are placed to face each other. The first side surfaces 111 are perpendicular to the second side surfaces 112. That is, the first side surfaces 111 and the second side surfaces 112 form a square tubular shape. The second side surface 112 has an area larger than the area of the first side surface 111. The second side surface 112 is perpendicular to the one direction. The bottom surface 113 closes an opening on the lower side of a square tube constituted by the first side surfaces 111 and the second side surfaces 112.

The cover 120 has a shape closing an opening of the case 110. The cover 120 is welded to an upper end part of the case 110. The cover 120 has a reference surface 120S. The reference surface 120S is constituted by the upper surface of the cover 120. The reference surface 120S is formed flatly.

A welded portion 140 formed by welding between the case 110 and the cover 120 is formed in a boundary portion between the case 110 and the cover 120. The welded portion 140 is formed in an annular shape. As illustrated in FIGS. 3, 4, the welded portion 140 includes a protrusion portion 142 and an overhanging portion 144. The protrusion portion 142 has a shape protruding upward from the reference surface 120S. The overhanging portion 144 has a shape overhanging outwardly from an outer side surface of the case 110. A protrusion amount of the protrusion portion 142 from the reference surface 120S is around 0.3 mm to 0.5 mm. An overhanging amount of the overhanging portion 144 from the outer side surface of the case 110 is around 0.3 mm to 0.5 mm.

The external terminals 130 have a shape projecting upward from the cover 120. The external terminals 130 are placed at respective positions distanced from each other in a width direction perpendicular to both of the one direction and the up-down directions. One of the external terminals 130 is a positive terminal, and the other one of them is a negative terminal.

The cell holder 200 holds the power storage cell 100. The cell holder 200 is made of resin, for example. The cell holder 200 includes a frame body 210 and an abutment wall 220.

The frame body 210 is placed around the power storage cell 100. The frame body 210 includes a pair of first side walls 211 and a second side wall 212.

The first side walls 211 face each other. The first side walls 211 face the first side surfaces 111, respectively. The first side wall 211 is formed in a flat-plate shape.

The second side wall 212 faces a corresponding one of the second side surfaces 112. The second side wall 212 connects the first side walls 211 to each other.

The second side wall 212 is formed in a flat-plate shape. The area of the second side wall 212 is larger than the area of each of the first side walls 211. An outer side surface of the second side wall 212 is perpendicular to respective outer side surfaces of the first side surfaces 111.

As illustrated in FIGS. 3, 4, the frame body 210 has a shape to be distanced from the overhanging portion 144 such that the frame body 210 avoids interference with the overhanging portion 144. More specifically, an inner side surface 211a of the first side wall 211 is distanced from the overhanging portion 144, and an inner side surface 212a of the second side wall 212 is distanced from the overhanging portion 144. A distance w (see FIG. 3) between the inner side surface 211a of the first side wall 211 and the first side surface 111 is set to be equal to or more than 0.5 mm. As illustrated in FIGS. 1, 3, a facing portion 224 is provided above a space between the inner side surface 211a of the first side wall 211 and the first side surface 111. As illustrated in FIGS. 1, 4, a space between the inner side surface 212a of the second side wall 212 and the second side surface 112 is opened upward. A rib may be provided on the inner side surface 212a of the second side wall 212 such that a cooling passage is formed between the second side wall 212 and the power storage cell 100.

The frame body 210 includes a side surface abutment portion 211b configured to abut with the outer side surface of the case 110. More specifically, the side surface abutment portion 211b projects from the inner side surface 211a of the first side wall 211 toward the first side surface 111 of the case 110 and abuts with the first side surface 111.

The abutment wall 220 abuts with the reference surface 120S of the cover 120. The abutment wall 220 is connected to an upper end part of the frame body 210. In the present embodiment, the abutment wall 220 is connected to an upper end part of the first side wall 211. Note that the abutment wall 220 may be connected to an upper end part of the second side wall 212. The abutment wall 220 includes a cover abutment portion 222, the facing portion 224, and a standing portion 226.

The cover abutment portion 222 includes an abutting surface 222a configured to abut with the reference surface 120S. The abutting surface 222a is formed flatly. The abutting surface 222a is constituted by the lower surface of the cover abutment portion 222. The cover abutment portion 222 has a shape extending in the up-down direction.

The facing portion 224 faces the protrusion portion 142 in the up-down direction. The facing portion 224 is connected to the cover abutment portion 222. More particularly, the facing portion 224 has a shape extending outwardly in the width direction (the right-left direction in FIG. 3) from an upper end part of the cover abutment portion 222. As illustrated in FIG. 3, the facing portion 224 has a shape recessed upward from the reference surface 120S such that the facing portion 224 avoids interference with the protrusion portion 142.

The facing portion 224 includes a facing surface 224a. The facing surface 224a is formed flatly. The facing surface 224a may be parallel to the reference surface 120S. A distance h (see FIG. 3) between the reference surface 120S and the facing surface 224a is set to be equal to or more than 0.5 mm. That is, the facing surface 224a is formed at a position distanced upward from the reference surface 120S by 0.5 mm or more.

The standing portion 226 rises from the upper end part of the frame body 210. More specifically, the standing portion 226 has a shape extending upward from the upper end part of the first side wall 211. An upper end part of the standing portion 226 is connected to the facing portion 224. An inner side surface of the standing portion 226 is formed to be flash with the inner side surface 211a of the first side wall 211. That is, the inner side surface of the standing portion 226 is distanced from the overhanging portion 144.

As described above, in the power storage module 10 of the present embodiment, the facing portion 224 in the cell holder 200 has a shape recessed upward from the reference surface 120S such that the facing portion 224 avoids interference with the protrusion portion 142, and the abutting surface 222a in the cover abutment portion 222 abuts with the reference surface 120S. This makes it possible to improve the accuracy of positioning between the power storage cell 100 and the cell holder 200 in the up-down direction.

In the above embodiment, as illustrated in FIG. 5, the facing portion 224 may further include a connecting surface 224b via which the abutting surface 222a is connected to the facing surface 224a. The connecting surface 224b has a shape gradually inclined upward as the connecting surface 224b is distanced from the abutting surface 222a. An angle θ formed between the reference surface 120S and the connecting surface 224b is set to be equal to or more than 50 degrees. Note that the connecting surface 224b may be formed in an arcuate shape corresponding to the outer shape of the protrusion portion 142.

Further, in the above embodiment, the frame body 210 may further include a bottom wall (not illustrated) placed below the bottom surface 113 of the case 110 and connected to at least either of the first side walls 211 and the second side wall 212.

A person skilled in the art will understand that the embodiment described above is a concrete example of the following aspects.

The power storage module according to the above embodiment includes a power storage cell and a cell holder. The cell holder is configured to hold the power storage cell. The power storage cell includes a case having a shape opened upward, and a cover having a shape closing an opening of the case, the cover being welded to the case. The case includes a pair of first side surfaces placed such that the first side surfaces face each other, and a pair of second side surfaces placed such that the second side surfaces face each other, the second side surfaces being perpendicular to the first side surfaces. The cover has a reference surface formed flatly. A welded portion formed by welding between the case and the cover is formed in a boundary portion between the case and the cover. The welded portion includes a protrusion portion having a shape protruding upward from the reference surface. The cell holder includes a frame body and an abutment wall. The frame body includes a pair of first side walls placed such that the first side walls face the first side surfaces, respectively, and a second side wall via which the first side walls are connected to each other, the second side wall facing a corresponding one of the second side surfaces. The abutment wall is connected to an upper end part of the frame body and configured to abut with the reference surface of the cover. The abutment wall includes a cover abutment portion including an abutting surface configured to abut with the reference surface, and a facing portion connected to the cover abutment portion, the facing portion facing the protrusion portion in the up-down direction. The facing portion has a shape recessed upward from the reference surface such that the facing portion avoids interference with the protrusion portion.

In the power storage module, the facing portion of the abutment wall in the cell holder has a shape recessed upward from the reference surface of the cover such that the facing portion avoids interference with the protrusion portion of the welding portion, and the abutting surface in the cover abutment portion abuts with the reference surface. This makes it possible to improve the accuracy of positioning between the power storage cell and the cell holder in the up-down direction.

Further, the second side surfaces may each have an area larger than the areas of the first side surfaces. In this case, the abutment wall may be connected to an upper end part of a corresponding one of the first side walls.

Further, the facing portion may have a facing surface formed at a position distanced upward from the reference surface by 0.5 mm or more.

With this configuration, it is possible to effectively avoid interference between the facing surface and the protrusion portion.

Further, the facing portion may further include a connecting surface via which the abutting surface is connected to the facing surface. The connecting surface may have a shape gradually inclined upward as the connecting surface is distanced from the abutting surface.

Further, the welded portion may include an overhanging portion having an shape overhanging outwardly from an outer side surface of the case. In this case, the frame body may have a shape to be distanced from the overhanging portion such that the frame body avoids interference with the overhanging portion.

In this case, the frame body may include a side surface abutment portion configured to abut with an outer side surface of the case.

With this configuration, it is possible to improve the accuracy of positioning between the power storage cell and the cell holder in a direction perpendicular to the up-down direction.

Note that it should be considered that the embodiment disclosed herein is just an example in all respects and is not limitative. The scope of the present disclosure is shown by Claims, not by the descriptions of the above embodiment, and further includes every modification made within the meaning and scope equivalent to Claims.

What is claimed is:

1. A power storage module comprising:
a power storage cell; and
a cell holder configured to hold the power storage cell, wherein:
the power storage cell includes
a case having a shape opened upward, and
a cover having a shape closing an opening of the case, the cover being welded to the case;
the case includes
a pair of first side surfaces placed such that the first side surfaces face each other, and
a pair of second side surfaces placed such that the second side surfaces face each other, the second side surfaces being perpendicular to the first side surfaces;
the cover has a reference surface formed flatly;
a welded portion formed by welding between the case and the cover is formed in a boundary portion between the case and the cover;
the welded portion includes a protrusion portion having a shape protruding upward from the reference surface;
the cell holder includes
a frame body including a pair of first side walls placed such that the first side walls face the first side surfaces, respectively, and a second side wall via which the first side walls are connected to each other, the second side wall facing a corresponding one of the second side surfaces, and
an abutment wall connected to an upper end part of the frame body and configured to abut with the reference surface of the cover;
the abutment wall includes
a cover abutment portion including an abutting surface configured to abut with the reference surface, and
a facing portion connected to the cover abutment portion, the facing portion facing the protrusion portion in an up-down direction; and
the facing portion has a shape recessed upward from the reference surface such that the facing portion avoids interference with the protrusion portion.

2. The power storage module according to claim 1, wherein:
the second side surfaces each have an area larger than areas of the first side surfaces; and
the abutment wall is connected to an upper end part of a corresponding one of the first side walls.

3. The power storage module according to claim 1, wherein the facing portion has a facing surface formed at a position distanced upward from the reference surface by 0.5 mm or more.

4. The power storage module according to claim 3, wherein:
the facing portion further includes a connecting surface via which the abutting surface is connected to the facing surface; and
the connecting surface has a shape gradually inclined upward as the connecting surface is distanced from the abutting surface.

5. The power storage module according to claim 1, wherein:
the welded portion includes an overhanging portion having an shape overhanging outwardly from an outer side surface of the case; and
the frame body has a shape to be distanced from the overhanging portion such that the frame body avoids interference with the overhanging portion.

6. The power storage module according to claim 1, wherein the frame body includes a side surface abutment portion configured to abut with an outer side surface of the case.
